(19) United States
(12) Patent Application Publication
(10) Pub. No.: US 2022/0334571 A1
(43) Pub. Date: Oct. 20, 2022

(54) METHOD AND SYSTEM FOR MONITORING A PLURALITY OF CRITICAL ASSETS ASSOCIATED WITH A PRODUCTION/PROCESS MANAGEMENT SYSTEM USING ONE OR MORE EDGE DEVICES

(71) Applicant: Larsen & Toubro Infotech Ltd, Mumbai (IN)

(72) Inventors: Ramkumar Thangavel, Chennai (IN); Rex Jesudas P, Chennai (IN)

(73) Assignee: Larsen & Toubro Infotech Ltd, Mumbai (IN)

(21) Appl. No.: 17/363,034

(22) Filed: Jun. 30, 2021

(30) Foreign Application Priority Data
Apr. 16, 2021 (IN) 202121017838

(51) Int. Cl. G05B 19/418; G06Q 10/06

(52) U.S. Cl. CPC G05B 19/41885; G06Q 10/06393; G05B 19/4183; G05B 19/41865

(57) ABSTRACT

The invention relates to a method and system for monitoring a plurality of critical assets (102a-102n) associated with a production/process management system using one or more edge devices (104a-104n). The one or more edge devices (104a-104n) track operations of the plurality of critical assets (102a-102n), which comprises obtaining consolidated information related to the operations of the plurality of critical assets (102a-102n). The one or more edge devices (104a-104n) then derive insights corresponding to the plurality of critical assets (102a-102n) based on the consolidated information using descriptive analytics and an AI/ML model (114) and derive a set of actionable insights to optimize the operations. The derived insights are then rendered in a real-time consolidated view, to enable a user to take immediate actions and decisions in relation to the plurality of critical assets (102a-102n).

### FIELD OF THE INVENTION

The invention generally relates to a method and system for monitoring a plurality of critical assets associated with a production/process management system. Specifically, the invention relates to a method and system for utilizing one or more edge devices for tracking operations of the plurality of critical assets to derive real-time insights and render the insights in a real-time consolidated view to enable users to take immediate actions and decisions.

### BACKGROUND OF THE INVENTION

Industrial automation is the use of control devices that control industrial processes and machinery by removing as much labor intervention as possible and replacing them with automated assembly operations. As new and efficient control technologies evolved, computerized automation control is being driven by the need for high accuracy, quality, precision and performance of industrial processes.

Computerized industrial automation control requires edge computing for processing and analyzing large volumes of sensor and other data in real-time in a distributed network such as, but not limited to, Internet-of-Things (IoT) environments to derive analytical meaning and predictive insights therefrom. The IoT ecosystem brings value to business operations through instrumentation of physical operations with high fidelity sensors, tracking events in operations with high frequency and turning sensor data into actionable analytic insights through software and services.

However, in the IoT environment, industries and enterprises may rely on remote data centers or cloud servers to host computing infrastructure and software applications needed to process and analyze locally generated sensor and device data in order to exploit economies of scale and system efficiencies. Furthermore, remote cloud-based computing and storage solutions have a number of shortcomings such as, but not limited to, distant location of remote data centers, irregular connectivity, insufficient bandwidth availability, lack of real-time analysis of data generated in local environments, and failure to provide potentially critical guidance or warnings back to the local environments in real-time.

Additionally, large volume and complexity of data that is generated from a plurality of critical components/assets in production lines (locally) of a manufacturing plant presents challenges for interpreting the data and obtaining proactive insights. Here, cloud-based data mining and machine-learning model generation, training, and application may be utilized. However, cloud-based machine learning lacks real-time responsiveness that may be critical in some situations in local environments. Additionally, without contextual knowledge of persons working in the local environment in the manufacturing plant, it is nearly impossible to obtain usable insights even if the entirety of the available data is transmitted to and analyzed in the cloud.

As various machine learning models are adapted to operate in a cloud environment, a number of challenges must be overcome to successfully implement machine learning in edge computing. Typical cloud-based machine learning models also operate well on batched data, such as is typically stored in cloud-based storage, but are not able to function in real-time on high velocity, high volume streaming data, such as is typically produced by multiple sensors, Supervisory Control And Data Acquisition (SCADA) systems, and Programmable Logic Controller (PLC), in industrial and other IoT environments, as well as for extraction of data from industrial assets or manufacturing plant equipment. Further, while typical cloud-based machine learning models may be easily updated or tuned in the cloud as additional batches of data are received and analyzed, a different approach is required for updating remote edge-based machine learning models.

Therefore, there is a need for an improved and intelligent edge computing platform which relies on Artificial Intelligence (AI)/Machine Learning (ML) to efficiently track and process data received from multiple assets and derive analytical meaning and predictive insights therefrom in real-time to take proactive and reactive decisions.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for monitoring a plurality of critical assets associated with a production/process management system using one or more edge devices in accordance with an embodiment of the invention.

FIG. 2 and FIG. 3 illustrate an edge device framework for monitoring the plurality of critical assets in accordance with an exemplary embodiment of the invention.

FIG. 4 illustrates an asset monitoring dashboard in accordance with an embodiment of the invention.

FIG. 5 illustrates a business Key Performance Indicators (KPI) monitoring dashboard in accordance with an embodiment of the invention.

FIG. 6 illustrates a ticket KPI monitoring dashboard in accordance with an embodiment of the invention.

FIG. 7 illustrates a flowchart of a method for monitoring a plurality of critical assets associated with a production/process management system using one or more edge devices in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the invention, it should be observed that the embodiments reside primarily in combinations of method steps and system components for monitoring a plurality of critical assets associated with a production/process management system by utilizing one or more edge devices for tracking operations of the plurality of critical assets to derive real-time insights and render the insights in a real-time consolidated view to enable users to take immediate actions and decisions.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Various embodiments of the invention disclose a method and system for monitoring a plurality of critical assets associated with a production/process management system using one or more edge devices. The one or more edge devices track operations of the plurality of critical assets across production lines of the production/process management system. The production/process management system can be, but need not be limited to, a manufacturing/production plant, an Enterprise Resource Planning (ERP) system, a Manufacturing Execution System (MES), a Programmable Logic Controller (PLC)/controller system and external sensors for any additional information required from the machine. A critical asset can be a mission critical asset that can be, but need not be limited to, a machine, an application, a component, and a service across a production line within a factory or manufacturing plant. The plurality of critical assets are onboarded in real-time to the production/process management system. The tracking is performed by obtaining consolidated information related to the operations of the plurality of critical assets. Thereafter, the one or more edge devices derive insights corresponding to the plurality of critical assets based on the consolidated information using descriptive analytics and an AI/ML model. A plurality of business KPIs related to the plurality of critical assets are monitored to derive a set of actionable insights to optimize the operations. Further, the one or more edge devices render the insights in a real-time consolidated view, to enable a user to take immediate actions and decisions in relation to the plurality of critical assets.

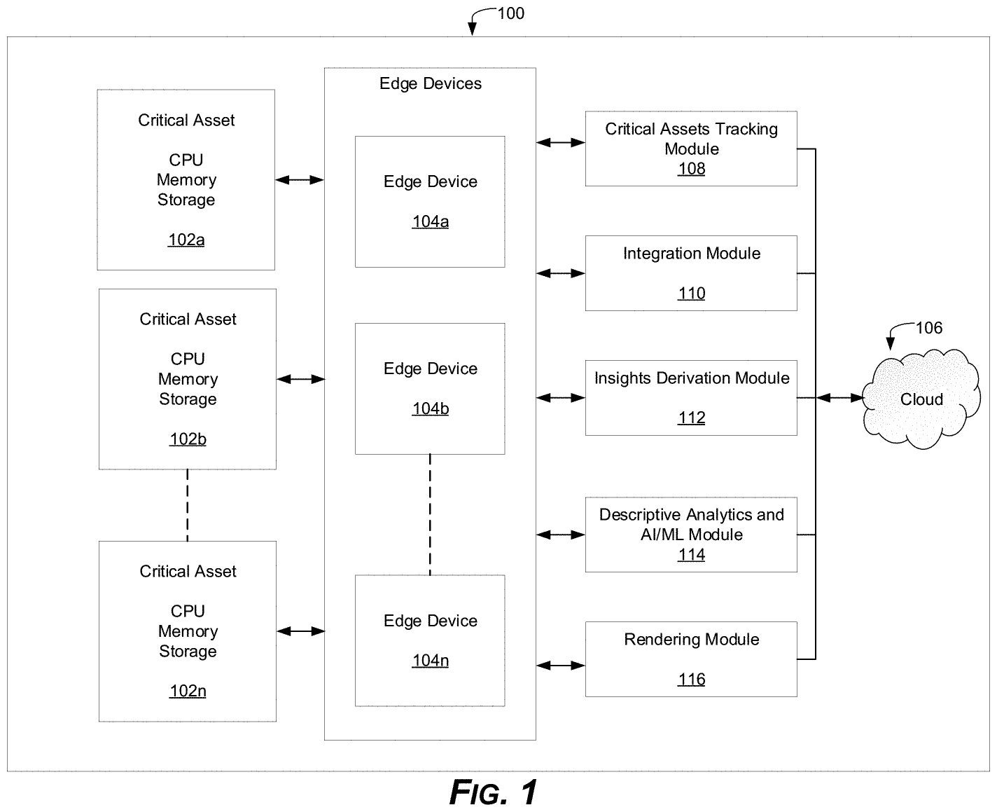

FIG. 1 illustrates a system 100 for monitoring a plurality of critical assets 102a-102n associated with a production/process management system using one or more edge devices 104a-104n in accordance with an embodiment of the invention.

The production/process management system can be, but need not be limited to, a manufacturing/production plant, an ERP system, an MES, a PLC system and external sensors for any additional information required from the machine.

A critical asset can be, but need not be limited to, a machine, an application, a component, and a service across a production line within a factory or manufacturing plant. Plurality of critical assets 102a-102n are onboarded in real-time to the production/process management system.

As illustrated in FIG. 1, each critical asset of plurality of critical assets 102a-102n comprises a central processing unit (CPU), memory and storage.

One or more edge devices 104a-104n comprise several modules in communication with cloud 106 for monitoring using one or more edge devices 104a-104n in the production/process management system. Functionalities of these modules are illustrated herein.

System 100 includes a critical assets tracking module 108 for tracking/monitoring operations of plurality of critical assets 102a-102n across production lines of the production/process management system and reporting it to one or more edge devices 104a-104n. Critical assets tracking module 108 obtains consolidated information related to the operations of plurality of critical assets 102a-102n. The consolidated information may comprise metadata related to plurality of critical assets 102a-102n. Critical assets tracking module 108 also monitors and manages CPU operations, memory and storage related to plurality of critical assets 102a-102n.

In accordance with an embodiment, each critical asset of plurality of critical assets 102a-102n is fitted with one or more external sensors for tracking operations of plurality of critical assets 102a-102n via critical assets tracking module 108 and reporting it to one or more edge devices 104a-104n. Furthermore, critical assets tracking module 108 communicates with one or more edge devices 104a-104n via an integration module 110. Integration module 110 comprises one or more built-in interfaces/connectors and plug-in interfaces for various custom protocols, to integrate the production/process management system with one or more edge devices 104a-104n.

The built-in interfaces/connectors and plug-in interfaces can be, but need not be limited to, Message Queuing Telemetry Transport (MQTT) interfaces, Open Platform Communications (OPC) interfaces and serial interface RS232 and RS485.

System 100 further includes an insights derivation module 112 which utilizes a descriptive analytics and AI/ML model 114 to derive insights corresponding to plurality of critical assets 102a-102n based on the consolidated information. Descriptive analytics and AI/ML model 114 are configured based on metadata and pre-configured rules and communicate with cloud 106 for analytics operations. Descriptive analytics and AI/ML model 114 can be, but need not be limited to, a domain specific data model and a plug-in work process model. Descriptive analytics and AI/ML model 114 perform descriptive analytics that helps in understanding insights from scheduling of production to packaging along with Root Cause Analysis (RCA). Descriptive analytics and AI/ML model 114 perform historical analysis of data, which helps in predicting parameters such as, but not limited to, production down, production output, and possible changes each process may have, and take immediate actions to correct the same.

In accordance with an embodiment, plurality of critical assets 102a-102n are configured by a metadata driven approach, wherein the configuration may include configuring thresholds pertaining to the operations of plurality of critical assets 102a-102n.

Insights derivation module 112 derives real-time insights by monitoring a plurality of business KPIs related to plurality of critical assets 102a-102n to derive a set of actionable insights to optimize the operations based on the consolidated information. The consolidated information may also provide a consolidated view of entire production line KPIs helping with insights of each process within the production line and consolidated view of all of the production lines within the manufacturing plant. Additionally, the consolidated information comprises display of real-time insights of plurality of critical assets 102a-102n connected with the production line and across the manufacturing plant in a single view, which helps in monitoring business KPIs. The plurality of KPIs can be, but need not be limited to, a cycle-time, Overall Equipment Effectiveness (OEE), Up-time, First-Yield Pass (FYP), and RCA. The derived insights can be, but need not be limited to, production, maintenance, quality and supply-chain, alerts and feedback in case of deviations in any one business KPI of the plurality of business KPIs, and predictions for scheduled maintenance.

In accordance with an embodiment, the alerts and feedback are provided using electronic communication and/or integration with a ticketing system. The electronic communication can be, but need not be limited to, email, chat, instant messaging, and social network messaging.

Finally, system 100 includes a rendering module 116 which receives and renders the derived insights in a real-time consolidated view. Rendering module 116 renders the insights to 102a-102n enable a user to take immediate actions and decisions in relation to plurality of critical assets 102a-102n. The consolidated view is rendered across one or more manufacturing plants in the production/process management system or across a globe via an Enterprise Command Centre.

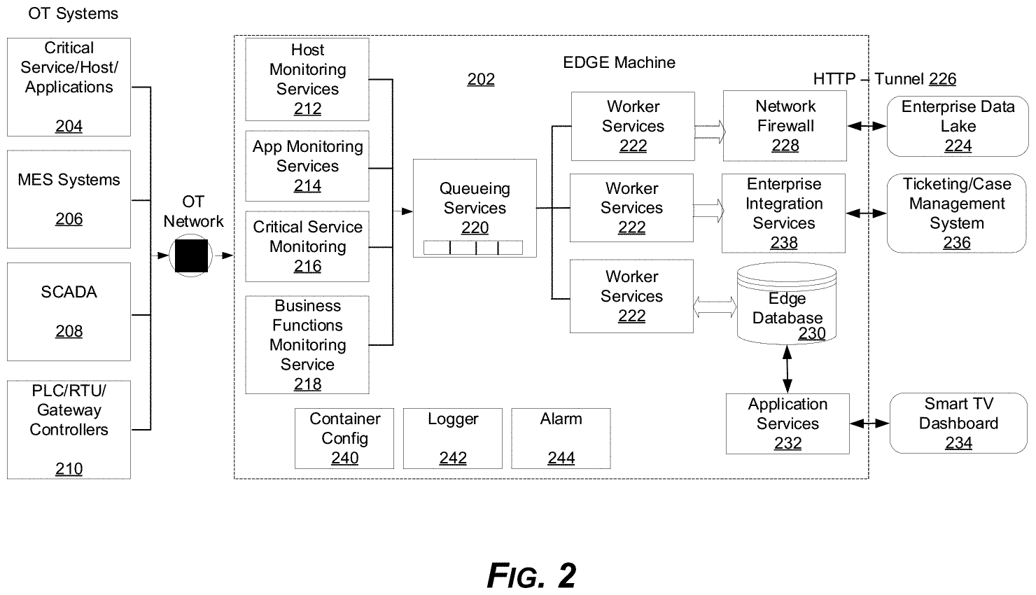

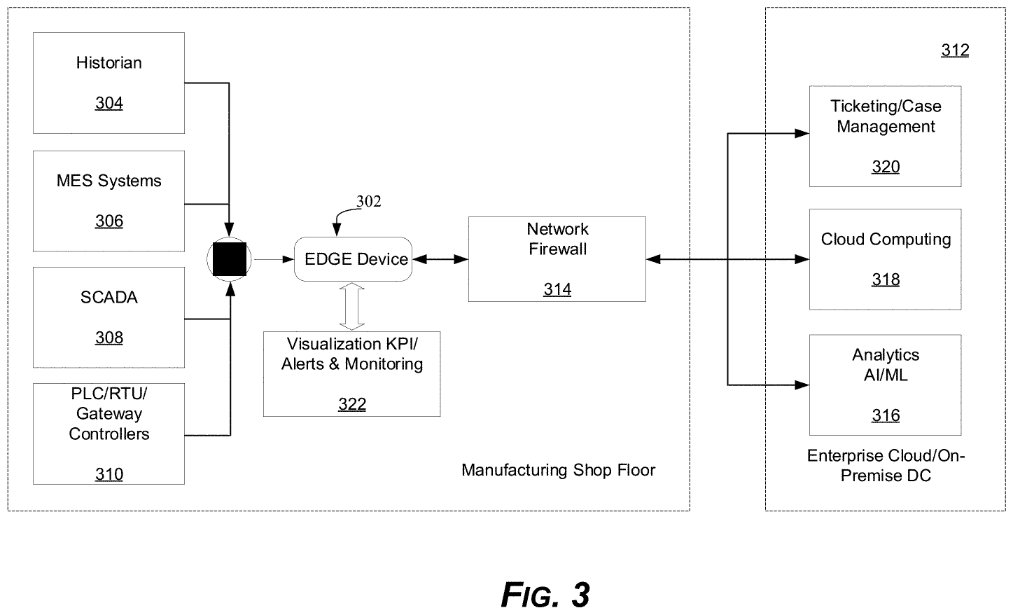

FIG. 2 and FIG. 3 illustrate an edge device framework for monitoring plurality of critical assets 102a-102n in accordance with an exemplary embodiment of the invention.

As illustrated in FIG. 2, an edge machine 202 is connected to Operational Technology (OT) systems such as, but not limited to, critical services/host/applications 204, MES systems 206, SCADA 208, and PLC/Remote Terminal Unit (RTU)/Gateway Controllers 210.

Edge machine 202 comprises host monitoring services 212, app monitoring services 214, critical service monitoring 216 and business functions monitoring service 218. Service monitoring daemons operate under horizontal scaling. The host monitoring daemons measure incoming data and the service monitoring daemons monitor availability of servers in real-time. Edge machine 202 further comprises queueing services 220 such as, but not limited to, MQTT queue messaging protocol, a messaging protocol used for transporting and communicating messages between plurality of critical assets 102a-102n that are connected in a network. The MQTT messaging protocol receives and processes one or more host data, service data and notification messages and transmits the processed data to an MQTT broker (server) which transmits the data to worker services 222.

The MQTT queue messaging protocol receives data such as, but not limited to, host data, service data and notification messages from the host monitoring and the service monitoring daemons. The host monitoring and service monitoring daemons communicate with one or more input devices such as, but not limited to, OPC/MES server and critical services, SCADA system, PLC, industrial scales, and printers. The host monitoring and service monitoring daemons communicate with the one or more input devices via the plurality of IP networks that can be, but need not be limited to, a business network, a package-line network, a SCADA network, and an automation PC network.

In an embodiment, the MQTT broker receives data using the MQTT messaging protocol and transmits the processed data to a cloud storage via a cloud ingestion mechanism which is further transmitted to a scalable data storage, Enterprise Data Lake 224 via a Hypertext Transfer Protocol Secure (HTTPS) Tunnel 226 via a firewall (network security system) 228.

In another embodiment, the MQTT broker transmits the processed data to an open-source relational database management system or an edge database 230 that is connected to application services 232 such as, but not limited to, web server internet information services (IIS), which facilitates information sharing via a plurality of platforms that can be, but need not be limited to, an internet, an intranet, and an extranet. The shared information is then presented on a plurality of display devices that can be, but need not be limited to, a smart TV 234, a smartphone, a computer, and a laptop.

In accordance with an embodiment, edge machine 202 is integrated with one or more case management tools (ticketing tools) 236 via enterprise integration services 238 that defines structures and automates the flow of work in the manufacturing/production plant, wherein one or more case management tools 236 log and track the issues associated with plurality of critical assets 102a-102n in real-time. Edge machine 202 further comprises modules such as, but not limited to, a container config 240, a logger 242, and an alarm 244.

Referring to FIG. 3, an edge device 302 is connected to a historian 304, MES systems 306, SCADA 308 and PLC/RTU/Gateway Controllers 310 via the one or more built-in interfaces/connectors and plug-in interfaces for a plurality of IP networks. The built-in interfaces/connectors and plug-in interfaces can be, but need not be limited to, MQTT interfaces, OPC interfaces and serial interface RS232 and RS485.

Edge device 302 further communicates with an enterprise cloud/on-premise data center 312 via a network firewall 314. Enterprise cloud/on-premise data center 312 comprise the following components: analytics AI/ML model 316, cloud computing 318 and ticketing/case management 320. Descriptive analytics and AI/ML model 316 process the data for predicting and providing feedback to machines and/or production lines. AI/ML model 316 can be one of a domain specific data model and a plug-in work process model, wherein AI/ML model 316 is configured based on metadata and pre-configured rules. Results of the analytics are then provided for visualization, KPI alerts generation and monitoring 322.

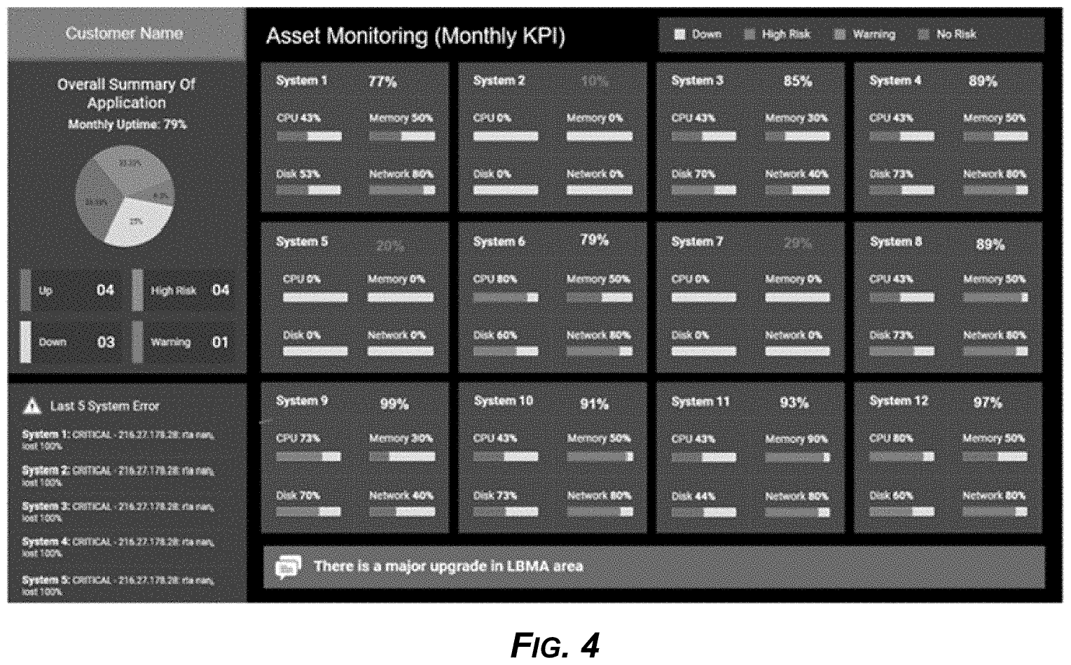

FIG. 4 illustrates an asset monitoring dashboard in accordance with an embodiment of the invention.

As illustrated in FIG. 4, the asset monitoring dashboard is segmented into multiple grids to display insights that are rendered using rendering module 116, wherein the insights are related to a plurality of devices that are connected to a network in the manufacturing plant in the production/process management system in accordance with an embodiment of the invention. The insights can be, but need not be limited to, CPU usage, memory usage, disk usage, and network usage. The dashboard further provides indication of various risk levels such as, but not limited to, down, high risk, warning, and no risk.

In accordance with an exemplary embodiment, the asset monitoring dashboard provides a summarized view of applications and monthly uptime of the plurality of devices. The dashboard further displays one or more errors in real-time to enable the user to take immediate actions and decisions in relation to plurality of critical assets 102a-102n and/or devices.

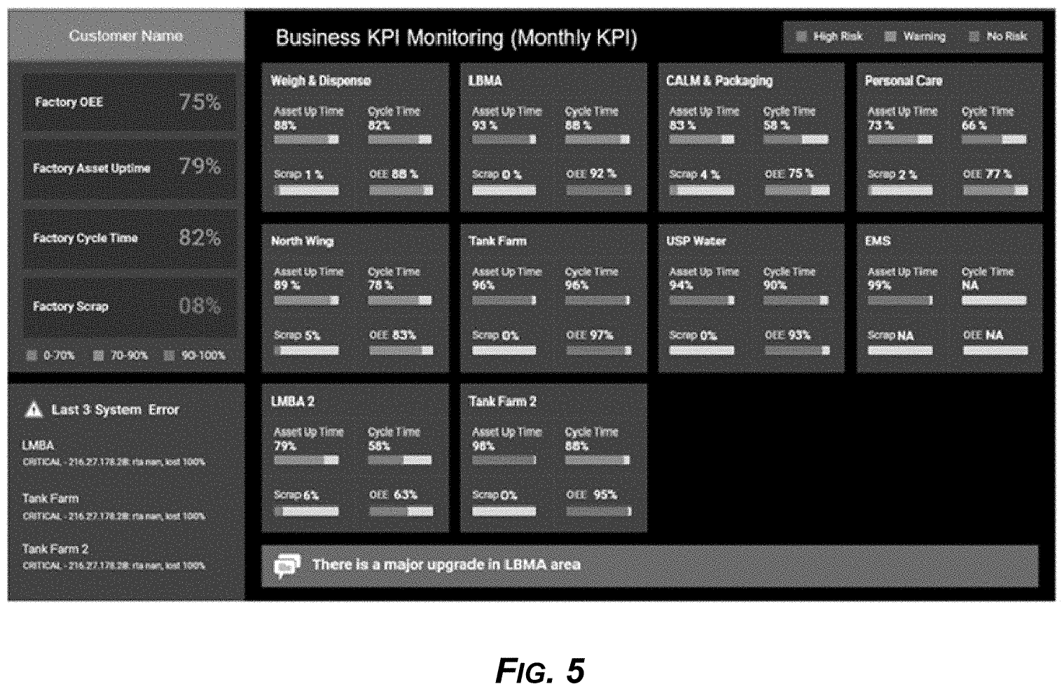

FIG. 5 illustrates a business KPI monitoring dashboard in accordance with an embodiment of the invention.

As illustrated in FIG. 5, the business KPI monitoring dashboard is segmented into multiple grids to display insights that are rendered using rendering module 116. The rendered insights are related to plurality of critical assets 102a-102n that are received from one or more edge devices 104a-104n in a real-time consolidated view. The business KPI monitoring dashboard provides the rendered insights in real-time in the form of alerts, feedback, and business KPI reports related to plurality of critical assets 102a-102n. The alerts and feedback are provided via an electronic communication and integration with a ticketing system. The business KPI reports comprises one or more of a cycle-time, OEE, up-time, FYP, scrap and RCA.

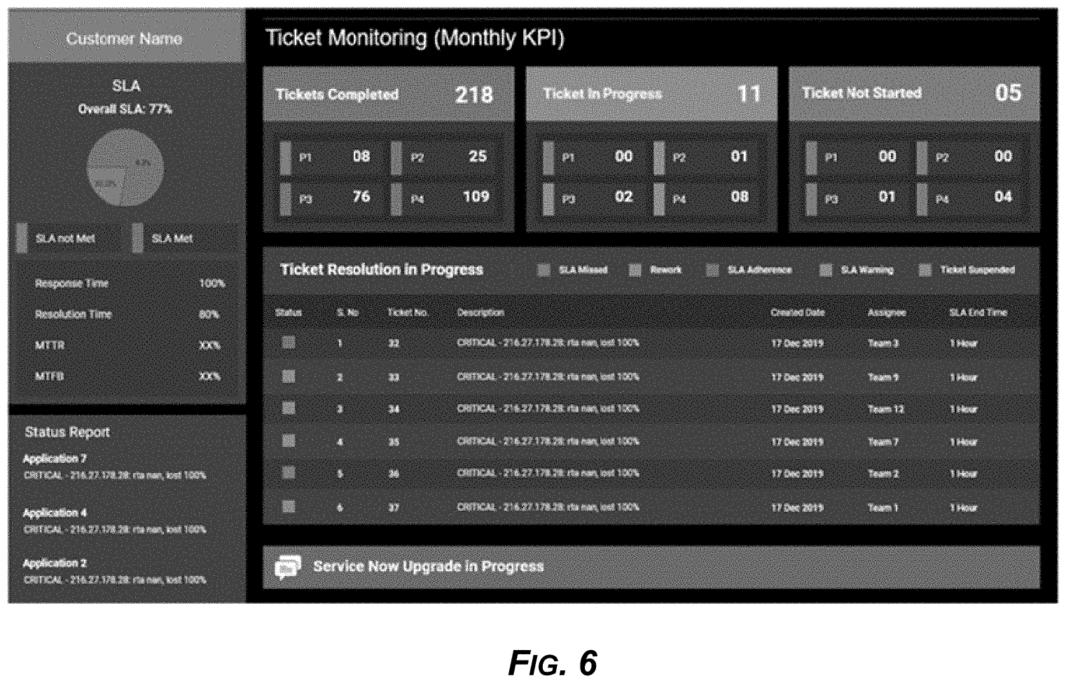

FIG. 6 illustrates a ticket KPI monitoring dashboard in accordance with an embodiment of the invention.

As illustrated in FIG. 6, the ticket KPI monitoring dashboard is segmented into multiple grids to display insights that are rendered using rendering module 116. The rendered insights are related to plurality of critical assets 102a-102n that are received from one or more edge devices 104a-104n in a real-time consolidated view. The ticket KPI monitoring dashboard provides the rendered insights in real-time that can be, but need not be limited to, tickets completed, tickets in progress, and tickets not started yet.

In an exemplary embodiment, the ticket KPI monitoring dashboard provides resolution progress of a number of tickets in real-time, wherein the ticket resolution can be, but need not be limited to, Service Level Agreements (SLAs) missed, rework, SLA adherence, SLA warning, and tickets suspended. The resolution progress further comprises details that can be, but need not be limited to, description, critical date, assignee, and SLA end time.

The ticket KPI monitoring dashboard also displays overall/aggregated percentage of SLAs that is accomplished into two categories such as, SLAs not met, and SLAs that have been met. The two categories include parameters such as, but not limited to, response time, resolution time, Mean Time to Recovery (MTTR), and Mean Time Between Failures (MTFB).

The ticket KPI monitoring dashboard further displays status reports of one or more applications, which include values related to criticality and lost percentage of the one or more applications. Additionally, the status report comprises alerts to the user such as, for example, alerts related to an upgradation process of the case management tools.

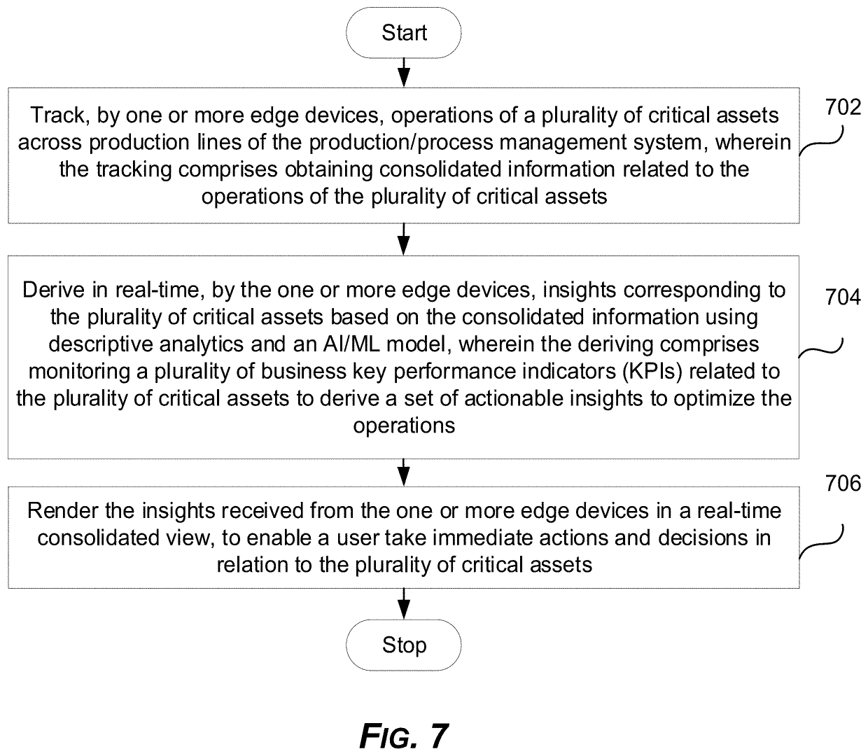

FIG. 7 illustrates a flowchart of a method for monitoring plurality of critical assets 102a-102n associated with a production/process management system using one or more edge devices 104a-104n in accordance with an embodiment of the invention.

As illustrated in FIG. 7, at step 702, critical assets tracking module 108 tracks operations of plurality of critical assets 102a-102n across production lines of the production/process management system and reports it to one or more edge devices 104a-104n. Plurality of critical assets 102a-102n are onboarded in real-time to the production/process management system. Critical assets tracking module 108 obtains consolidated information related to the operations of plurality of critical assets 102a-102n. The consolidated information obtained by critical assets tracking module 108 may comprise metadata related to plurality of critical assets 102a-102n.

In accordance with an embodiment, each critical asset of plurality of critical assets 102a-102n is fitted with one or more external sensors for tracking operations of plurality of critical assets 102a-102n via critical assets tracking module 108 and reporting it to one or more edge devices 104a-104n. Furthermore, critical assets tracking module 108 communicates with one or more edge devices 104a-104n via integration module 110. Integration module 110 comprises one or more built-in interfaces/connectors and plug-in interfaces for various custom protocols, to integrate the production/process management system with one or more edge devices 104-104n.

The built-in interfaces/connectors and plug-in interfaces can be, but need not be limited to, MQTT interfaces, OPC interfaces and serial interface RS232 and RS485.

At step 704, insights derivation module 112 utilizes descriptive analytics and AI/ML model 114 to derive insights corresponding to plurality of critical assets 102a-102n based on the consolidated information. Descriptive analytics and AI/ML model 114 are configured based on metadata and pre-configured rules and communication with cloud 104 for performing analytics operations. Descriptive analytics and AI/ML model 114 can be, but need not be limited to, a domain specific data model and a plug-in work process model.

Insights derivation module 112 derives real-time insights by monitoring a plurality of business key performance indicators (KPIs) related to plurality of critical assets 102a-102n to derive a set of actionable insights to optimize the operations based on the consolidated information. The consolidated information may also provide a consolidated view of entire production line KPIs helping with insights of each process within the production line and consolidated view of all of the production lines within the manufacturing plant. Additionally, the consolidated information comprises display of real-time insights of plurality of critical assets 102a-102n connected with the production line and across the manufacturing plant in a single view, which helps in monitoring business KPIs. The plurality of KPIs can be, but need not be limited to, a cycle-time, Overall Equipment Effectiveness (OEE), Up-time, First-Yield Pass (FYP), and Root Cause Analysis (RCA). The derived insights can be, but need not be limited to, production, maintenance, quality and supply-chain, alerts and feedback case of deviations in any one business KPI of the plurality of business KPIs, and predictions for scheduled maintenance.

In accordance with an embodiment, the alerts and feedback are provided via electronic communication and/or integration with a ticketing system. The electronic communication can be, but need not be limited to, email, chat, instant messaging, and social network messaging.

At step 706, rendering module 116 receives and renders the derived insights in a real-time consolidated view. Rendering module 116 renders the insights to enable a user to take immediate actions and decisions in relation to plurality of critical assets 102a-102n. Rendering module 116 receives and renders the derived insights in a real-time consolidated view across one or more manufacturing plants in the production/process management system or across a globe via an Enterprise Command Centre.

The present invention is advantageous in that it provides a solution that facilitates integration of manufacturing systems/devices in a manufacturing plant using in-built interfaces to proactively and reactively derive real-time and productive insights. Further, the present invention enables integration of production, maintenance, quality and supply-chain in real-time fashion using one or more edge devices to obtain the real-time insights, which in turn facilitate users or administrators in the manufacturing plant to take immediate decisions and action plans. The one or more edge devices help to make quick decisions by virtue of getting insights about critical assets in real-time with substantially no latency, which in turn helps to increase industrial productivity.

Furthermore, the present invention provides a solution that proactively identifies problems in the manufacturing plant and provides real-time alerts, notifications, and feedback to the users to take immediate actions for smooth running of critical assets in the manufacturing plant, thus optimizing the revenue.

Those skilled in the art will realize that the above recognized advantages and other advantages described herein are merely exemplary and are not meant to be a complete rendering of all of the advantages of the various embodiments of the present invention.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention. The computing device includes a processor, a memory, a nonvolatile data storage, a display, and a user interface.

In the foregoing specification, specific embodiments of the present invention have been described. However, one of ordinary skill in the art appreciates that various modifications and changes can be made without departing from the scope of the present invention. Accordingly, the specification and figures are to be regarded in an illustrative rather than a restrictive sense, and all such modifications are intended to be included within the scope of the present invention.

I/We claim:

1. A method for monitoring a plurality of critical assets (102a-102n) associated with a production/process management system using at least one edge device (104a-104n), the method comprising:
tracking, by the at least one edge device (104a-104n), operations of the plurality of critical assets (102a-102n) across production lines of the production/process management system, wherein the tracking comprises obtaining consolidated information related to the operations of the plurality of critical assets (102a-102n);
deriving in real-time, by the at least one edge device (104a-104n), insights corresponding to the plurality of critical assets (102a-102n) based on the consolidated information using descriptive analytics and an AI/ML model (114), wherein the deriving comprises monitoring a plurality of business key performance indicators (KPIs) related to the plurality of critical assets (102a-102n) to derive a set of actionable insights to optimize the operations; and
rendering the insights received from the at least one edge device (104a-104n) in a real-time consolidated view, to enable a user to take immediate actions and decisions in relation to the plurality of critical assets (102a-102n).

2. The method as claimed in claim 1, wherein the production/process management system is one of a manufacturing/production plant, an Enterprise Resource Planning (ERP) system, a Manufacturing Execution System (IVIES), Programmable Logic Controller (PLC)/controller system and external sensors for any additional information required from the machine.

3. The method as claimed in claim 1, wherein a critical asset is at least one of a machine, an application, a component, and a service across a production line within a factory or manufacturing plant.

4. The method as claimed in claim 3 further comprises onboarding a critical asset in real-time to the production/process management system.

5. The method as claimed in claim 1, wherein the tracking comprises utilizing at least one of built-in interfaces/connectors and plug-in interfaces for various custom protocols, to integrate the production/process management system with the at least one edge device (104a-104n).

6. The method as claimed in claim 5, wherein the built-in interfaces/connectors and plug-in interfaces comprise at least one of Message Queuing Telemetry Transport (MQTT) interfaces, Open Platform Communications (OPC) interfaces and serial interface RS232 and RS485.

7. The method as claimed in claim 1, wherein the AI/ML model (114) is one of a domain specific data model and a plug-in work process model, wherein a configuration of the AI/ML model (114) is metadata driven and based on pre-configured rules.

8. The method as claimed in claim 1, wherein a business KPI comprises at least one of a cycle-time, Overall Equipment Effectiveness (OEE), Up-time, First-Yield Pass (FYP), and Root Cause Analysis (RCA).

9. The method as claimed in claim 1, wherein the insights comprise at least one of insights related to production, maintenance, quality and supply-chain, alerts and feedback in case of deviations in at least one business KPI of the plurality of business KPIs, and predictions for scheduled maintenance.

10. The method as claimed in claim 9, wherein the alerts and feedback are provided via at least one of an electronic communication and integration with a ticketing system (236).

11. The method as claimed in claim 1, wherein the consolidated view is rendered across at least one manufacturing plant in the production/process management system or across the globe via an Enterprise Command Centre.

12. A system (100) for monitoring a plurality of critical assets (102a-102n) associated with a production/process management system using at least one edge device (104a-104n), the system (100) comprising:
a memory;
a processor communicatively coupled to the memory, wherein the processor is configured to:
track, by the at least one edge device (104a-104n), operations of the plurality of critical assets (102a-102n) across production lines of the production/process management system, wherein the processor is configured to obtain consolidated information related to the operations of the plurality of critical assets (102a-102n);
derive in real-time, by the at least one edge device (104a-104n), insights corresponding to the plurality of critical assets (102a-102n) based on the consolidated information using descriptive analytics and an AI/ML model (114), wherein the processor is configured to monitor a plurality of business key performance indicators (KPIs) related to the plurality of critical assets (102a-102n) to derive a set of actionable insights to optimize the operations; and
render the insights received from the at least one edge device (104a-104n), in a real-time consolidated view, to enable a user to take immediate actions and decisions in relation to the plurality of critical assets (102a-102n).

13. The system as claimed in claim 12, wherein the production/process management system is one of a manufacturing/production plant, an Enterprise Resource Planning (ERP) system, a Manufacturing Execution System (MES), Programmable Logic Controller (PLC)/controller system and external sensors for any additional information required from the machine.

14. The system as claimed in claim 12, wherein a critical asset is at least one of a machine, an application, a component, and a service across a production line within a factory or manufacturing plant.

15. The system as claimed in claim 12, wherein the processor is further configured to onboard a critical asset in real-time to the production/process management system.

16. The system as claimed in claim 12, wherein the processor is configured to utilize at least one of built-in interfaces/connectors and plug-in interfaces for various custom protocols, to integrate the production/process management system with the at least one edge device (104a-104n).

17. The system as claimed in claim 16, wherein the built-in interfaces/connectors and plug-in interfaces comprise at least one of Message Queuing Telemetry Transport (MQTT) interfaces, Open Platform Communications (OPC) interfaces and serial interface RS232 and RS485.

18. The system as claimed in claim 12, wherein the AI/ML model (114) is one of a domain specific data model and a plug-in work process model, wherein a configuration of the AI/ML model (114) is metadata driven and based on pre-configured rules.

19. The system as claimed in claim 12, wherein a business KPI comprises at least one of a cycle-time, Overall Equipment Effectiveness (OEE), Up-time, First-Yield Pass (FYP), and Root Cause Analysis (RCA).

20. The system as claimed in claim 12, wherein the insights comprise at least one of insights related to production, maintenance, quality and supply-chain, alerts and feedback in case of deviations in at least one KPI of the plurality of business KPIs, and predictions for scheduled maintenance.
